(19) United States
(12) Patent Application Publication
(10) Pub. No.: US 2020/0374507 A1
(43) Pub. Date: Nov. 26, 2020

(54) STEREO IMAGE DISPLAY APPARATUS CAPABLE OF ENHANCING IMAGE QUALITY

(71) Applicant: Lixel Inc., TAIPEI CITY (TW)

(72) Inventors: CHUN-HSIANG YANG, Hsinchu City (TW); YI-PAI HUANG, Hsinchu City (TW); CHIH-HUNG TING, New Taipei City (TW); KAI-CHIEH CHANG, Kaohsiung City (TW); JUI-YI WU, Miaoli County (TW); WEI-AN CHEN, Hsinchu County (TW); Yu-Chen Chou, Taipei City (TW)

(21) Appl. No.: 16/416,283

(22) Filed: May 20, 2019

(51) Int. Cl. H04N 13/30; G02B 27/09

(52) U.S. Cl. CPC H04N 13/30; G02B 27/0961

(57) ABSTRACT

A stereo image display apparatus includes a display device, a lens array layer and a shielding unit. The lens array layer is disposed adjacent to a display surface of the display device, and the lens array layer includes a plurality of lenses. The shielding unit is disposed between the display device and the lens array layer, or is disposed on the display device, or is disposed on the lens array layer. The shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

### FIELD OF THE DISCLOSURE

The present disclosure relates to a stereo image display apparatus, and more particularly to a stereo image display apparatus capable of enhancing image quality.

### BACKGROUND OF THE DISCLOSURE

Generally, conventional stereo image display apparatuses mainly employ the binocular vision fusion imaging technology. Regarding these kinds of image display apparatuses, users have to see a stereo image at a frontal viewing angle, or an image depth cannot be too far away from a display surface of the display apparatuses. When the stereo image display apparatuses are used in certain situations, such as aviation terrain models, building models, and 3D medical training devices, the stereo image display apparatuses are generally placed horizontally. In these situations, viewers will naturally stare at the image from an oblique angle, rather than the frontal viewing angle that the conventional stereo image display apparatuses can provide. Moreover, the conventional stereo image display apparatuses provide users with visual stimuli in only one direction, i.e., with the image projecting out or sinking in. Therefore, the conventional stereo image display apparatuses cannot provide a vivid sensation as if the image is escaping from the confines of a plane of the display surface and floating in mid-air.

The Taiwan Patent Publication No. 1614533 discloses a stereo image display apparatus including a flat panel display, a lens array layer and a microstructure layer. The flat panel display has a display surface. The lens array layer is disposed on the display surface of the flat panel display. The lens array layer includes a base portion and a plurality of lenses with light focusing function. The lens array layer is configured to adjust light field. The microstructure layer is disposed on the lens array layer, and the microstructure layer includes a base material and a plurality of microstructures. The microstructure layer is configured to modulate a direction of light emitted from the flat panel display. Accordingly, the stereo image display apparatus is capable of displaying a stereo image floating in mid-air and enabling a user to see the stereo image at an oblique viewing angle. However, the ineffective areas or edges of the lenses of the conventional stereo image display apparatuses may cause problems such as light leakage or aberrations so that image quality of the stereo image display apparatus may be reduced.

In this regard, the present disclosure provides a stereo image display apparatus capable of enhancing image quality to overcome the aforementioned drawbacks.

### SUMMARY OF THE DISCLOSURE

In response to the above-referenced technical inadequacies, the present disclosure provides a stereo image display apparatus capable of enhancing image quality by blocking or turning off pixels that cause degradation of image quality.

In one aspect, the present disclosure provides a stereo image display apparatus capable of enhancing image quality. The stereo image display apparatus includes a display device, a lens array layer and a shielding unit. The display device has a display surface and an image algorithm unit. The lens array layer is disposed adjacent to the display surface of the display device, and the lens array layer includes a plurality of lenses. The shielding unit is disposed between the display device and the lens array layer. The shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

In one aspect, the present disclosure also provides a stereo image display apparatus capable of enhancing image quality. The stereo image display apparatus includes a display device, a lens array layer and a shielding unit. The display device has a display surface and includes an image algorithm unit. The lens array layer is disposed adjacent to the display surface of the display device, and the lens array layer includes a plurality of lenses. The shielding unit is disposed on the display device or disposed in the display device. The shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

In one aspect, the present disclosure also provides a stereo image display apparatus capable of enhancing image quality. The stereo image display apparatus includes a display device, a lens array layer and a shielding unit. The display device has a display surface and includes an image algorithm unit. The lens array layer is disposed adjacent to the display surface of the display device, and the lens array layer includes a plurality of lenses. The shielding unit is disposed on the lens array layer. The shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

Therefore, the stereo image display apparatus of the present disclosure includes a display device, a lens array layer and a shielding unit. The shielding unit includes a plurality of light transmitting regions and at least one light shielding region. The light transmitting regions respectively correspond in position to the lenses of the lens array layer. The light shielding region is located at a periphery of the light transmitting regions. The light shielding region is configured to shield light. The light shielding region of the shielding unit is configured to shield ineffective areas or edges of the lenses to avoid problems such as light leakage or aberrations. Accordingly, the image quality of the stereo image display apparatus can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a planar view showing a stereo image display apparatus according to a first embodiment of the present disclosure.

FIG. 2 is a schematic view showing a lens array layer arranged in an aligned arrangement in the stereo image display apparatus according to the first embodiment of the present disclosure.

FIG. 3 is a schematic view showing the lens array layer arranged in a staggered arrangement in the stereo image display apparatus according to the first embodiment of the present disclosure.

FIG. 4 is a schematic view showing a single lens which is focusing light in the stereo image display apparatus according to the first embodiment of the present disclosure.

FIG. 5 is a schematic view showing a shielding unit of the stereo image display apparatus as the lens array layer is arranged in the aligned arrangement according to the first embodiment of the present disclosure.

FIG. 6 is a schematic view showing a shielding unit of the stereo image display apparatus as the lens array layer is arranged in the staggered arrangement according to the first embodiment of the present disclosure.

FIG. 7 is a planar view showing a stereo image display apparatus according to a second embodiment of the present disclosure.

FIG. 8 is a planar view showing a stereo image display apparatus according to a third embodiment of the present disclosure.

FIG. 9 is a planar view showing a stereo image display apparatus according to a fourth embodiment of the present disclosure.

FIG. 10 is a planar view showing a stereo image display apparatus according to a fifth embodiment of the present disclosure.

FIG. 11 is a planar view showing a stereo image display apparatus according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

A first embodiment provides a stereo image display apparatus capable of improving image quality. The stereo image display apparatus can be used in many industries such as optoelectronics, medical, military, exhibition, display, education, entertainment, and consumer electronics. The stereo image display apparatus can be used in an active image display device or a passive image display device, but the present disclosure is not limited thereto.

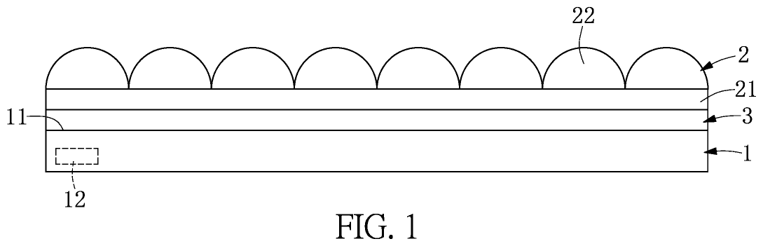

Referring to FIG. 1, the stereo image display apparatus includes a display device 1, a lens array layer 2 and a shielding unit 3. The stereo image display apparatus can alter a stereo image that a user sees by altering a displayed image so that the user can see the stereo image at different viewing angles.

The display device 1 can be a typical flat panel display. The display device 1 has a display surface 11 for displaying an un-reconstructed planar image. The lens array layer 2 is disposed adjacent to the display surface 11 of the display device 1, and the lens array layer 2 is preferably disposed above the display device 1. The lens array layer 2 can be arranged in contact with the display surface 11 of the display device 1. The lens array layer 2 can also be arranged spaced apart from the display surface 11 of the display device 1. In addition, a middle layer can be disposed between the display surface 11 of the display device 1 and the lens array layer 2.

The display device 1 is disposed at a bottom layer of the stereo image display apparatus and is configured to display an un-reconstructed planar image that has not been reproduced by light. The planar image can be reconstructed as an integral image by the lens array of the lens array layer 2 so that a 3D stereo image can be reproduced. Moreover, the display device 1 located at the bottom layer only needs to display a target image. Therefore, the display device 1 can be any type of hardware including, but not limited to, a mobile phone, a tablet, a flat panel display, a printed image, an engraved image, or a projection display image. In addition, the display device 1 can also be a self-luminous display or a passive display. In the present embodiment, the display device 1 is a typical flat panel display.

The lens array layer 2 is disposed at a top layer of the stereo image display apparatus and has a light field adjusting function. The lens array layer 2 is configured to adjust an angle of light of a 3D object and is configured to reconstruct the un-reconstructed planar image on the display surface 11 so that the user can see a 3D stereo image. The curvature of each lens 22 of the lens array layer 2 is determined by the material of each of the lenses 22. The curvatures of the lenses 22 of the lens array layer 2, as well as the combination of the lenses 22 and the display device 1 located at the bottom layer, determine the height, the range of viewing angle and the clarity of the 3D stereo image.

In the present embodiment, the lens array layer 2 is made of a material with good optical characteristics, which includes, but is not limited to, polymethylmethacrylate (PMMA), polycarbonate (PC), polyethylene (PE), glass and other light-transmissive materials. The lens array layer 2 includes a base portion 21 and the plurality of lenses 22. The lenses 22 can be circular, respectively. The lenses 22 are disposed on a surface of the base portion 21. That is, the lenses 22 are disposed on a surface of the base portion 21 away from the display device 1, but the arrangement and the structure of the lens array layer 2 are not limited to the present embodiment. Moreover, the lenses 22 have a light focusing function, and the lens array layer 2 is configured to reconstruct an un-reconstructed planar image displayed by the display surface 11 as an integral image to produce a stereo image.

A conventional naked-eye 3D stereo image display apparatus has a problem of viewing angle so that a user cannot see the stereo image at an oblique viewing angle. More specifically, when the user is in front of the display device 1 (i.e., zero order viewing zone), the display device 1 has a limited viewing angle zone for the user. Once the user's sight is out of the viewing angle zone, the user will not see the correct stereo image corresponding to the viewing angle of the user. On the contrary, the main feature of the present embodiment is that even when the user is not in front of the display device 1, the user can still see the correct 3D stereo image at an oblique viewing angle. In order to allow the user to see the correct stereo image at the oblique viewing angle, the present embodiment employs an oblique angle image display method instead of a zero order (forward) image display method. That is, the paths of light beams will be converged in an oblique direction so that the user can see the correct stereo image at the oblique viewing angle. It should be noted that the stereo image display apparatus of the present embodiment also allows the user to see the correct stereo image at a frontal viewing angle.

The display device 1 of the present embodiment can be of any specification as long as it can be applied with an image algorithm. In other words, the display device 1 includes an image algorithm unit 12 that includes the image algorithm. The image used in the display device 1 is calculated by the image algorithm. This calculation is matched to the configuration of the lens array layer 2, which predicts various possible paths of light beams to calculate the relative position of the image. Since the image algorithm is not the focus of the present embodiment, the detail of the image algorithm will not be reiterated herein.

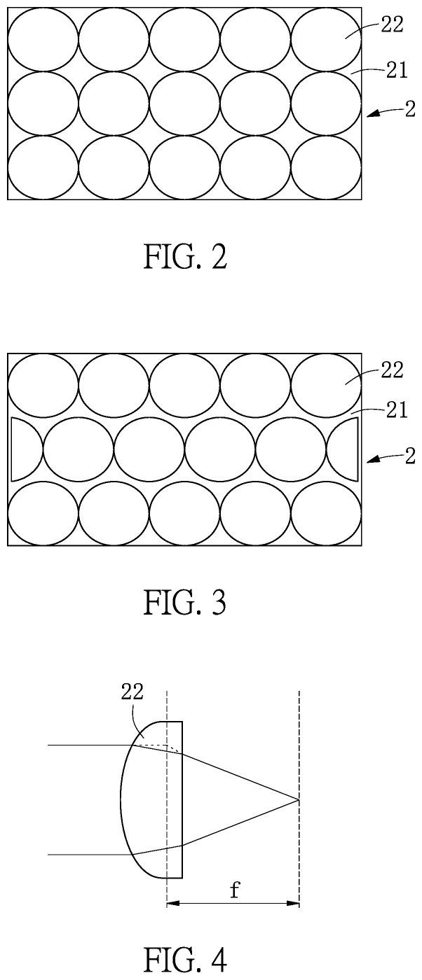

The lens array layer 2 of the present embodiment has a significant correlation to the display effect. Referring to FIG. 2 and FIG. 3, the lens array layers 2 can be arranged in a rectangular arrangement or a hexagonal arrangement; that is, the lenses 22 in each two adjacent columns are arranged in an aligned arrangement (FIG. 2) or in a staggered arrangement (FIG. 3). Further, each of the arrangements can be used to produce a 3D stereo image. The lenses 22 of the lens array layer 2 are the microstructures having light focusing function. The light focusing function of each of the lenses 22 can be determined according to the refractive index (n value) of its material. Each of the lenses 22 transmits light having a wavelength range of 300 nm to 1100 nm. Each of the lenses 22 conforms to Lensmaker's equation (FIG. 4): 1/f=(n−1)(1/R1+1/R2), in which R1 and R2 are the respective radiuses of curvature of bilateral surfaces of the lens 22, f is the focal length of the lens 22, and n is the refractive index of the lens 22. In addition, each of the lenses 22 has a diameter of 100 um to 5 mm, which is adapted to the pixel size of different display devices.

The shielding unit 3 is disposed between the display device 1 and the lens array layer 2, but the present disclosure is not limited thereto. For example, the shielding unit 3 can also be disposed (or be formed) on the display 1 or on the lens array layer 2, or in other dielectric layers. The shielding unit 3 is configured to block or turn off pixels that cause degradation of image quality by using a hardware manner or a software manner to improve the image quality of the stereo image display apparatus.

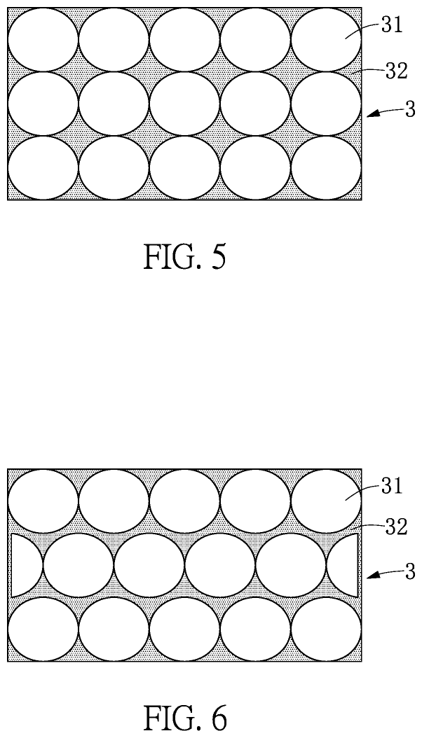

In the present embodiment, the shielding unit 3 is a structure having a solid body. The shielding unit 3 is disposed between the display device 1 and the lens array layer 2. The shielding unit 3 includes a plurality of light transmitting regions 31 and at least a light shielding region 32 as shown in FIG. 5 and FIG. 6. In the present embodiment, the light transmitting regions 31 are made of a light transmissive material to have light transmissivity. The light transmitting regions 31 respectively correspond in position to the lenses 22. The light transmitting regions 31 and the lenses 22 have circular shapes corresponding to each other. The light transmitting regions 31 respectively correspond to effective regions of the lenses 22. The light shielding region 32 does not have light transmissivity. The light shielding region 32 is located at a periphery of the light transmitting regions 31. The light shielding region 32 is configured to shield light. In the present embodiment, the light transmitting regions 31 can be formed on a light transmitting plate, and the light shielding region 32 can be formed by the method of inkjet or the like. Accordingly, the light shielding region 32 is located at the periphery of the light transmitting regions 31. The light shielding region 32 of the shielding unit 3 is configured to shield ineffective areas or edges of the lenses 22 to avoid problems such as light leakage or aberrations.

Accordingly, the present embodiment provides a stereo image display apparatus which can be applied to a frontal viewing angle and an oblique viewing angle. The stereo image display apparatus, in conjunction with the hardware arrangement, controls the direction of the light beams emitted from each pixel in the display device 1 through the optical element. The hardware system of the present embodiment includes relative simple optical elements, such as the display device 1, the lens array layer 2 and the shielding unit 3, which can be packaged into a package. Also, the hardware system can be configured to display a realistic stereo image in mid-air by virtue of the designed pixel size, system gap, lens size and focal length, and by virtue of the integral image principle in cooperation with the screen output signal calculated by the particular algorithm. In terms of hardware, the stereo image display apparatus of the present embodiment requires only one display device 1, a lens array layer 2 and a shielding unit 3 to achieve the floating stereo image without using other optical films, thereby providing a relatively simple structure.

### Second Embodiment

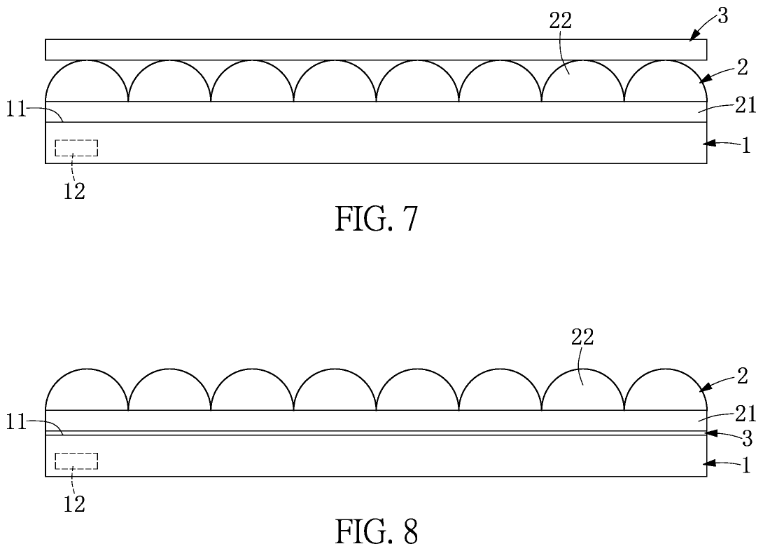

Referring to FIG. 7, a second embodiment of the present disclosure is illustrated, the present embodiment is substantially the same as the first embodiment, and the difference is that the shielding unit 3 of the present embodiment is disposed on the lens array layer 2. That is, the shielding unit 3 is disposed on a side of the lens array layer 2 away from the display device 1. In the present embodiment, the shielding unit 3 is a structure having a solid body. The shielding unit 3 includes a plurality of light transmitting regions 31 and at least one light shielding region 32 as shown in FIG. 5 and FIG. 6. The light shielding region 32 is located at a periphery of the light transmitting regions 31. The light shielding region 32 is configured to shield light. The light shielding region 32 of the shielding unit 3 is configured to shield ineffective areas or edges of the lenses 22 to avoid problems such as light leakage or aberrations. The shielding unit 3 is disposed on the lens array layer 2, and the position between the shielding unit 3 and the lens array layer 2 can include no other optical element layer, but the present disclosure is not limited thereto. The position between the shielding unit 3 and the lens array layer 2 can include other optical element layers.

### Third Embodiment

Referring to FIG. 8, a third embodiment of the present disclosure is illustrated, the present embodiment is substantially the same as the first embodiment, and the difference is that the shielding unit 3 of the present embodiment is disposed on a side of the lens array layer 2 close to the display device 1. The shielding unit 3 can be disposed on the base portion 21 of the lens array layer 2. That is, the shielding unit 3 can be disposed on a side of the base portion 21 of the lens array layer 2 close to the display device 1. As shown in FIG. 5 and FIG. 6, the light transmitting regions 31 and the light shielding region 32 can be formed on the base portion 21 of the lens array layer 2 by the method of inkjet or the like. The light shielding region 32 of the shielding unit 3 is configured to shield ineffective areas or edges of the lenses 22 to avoid problems such as light leakage or aberrations.

### Fourth Embodiment

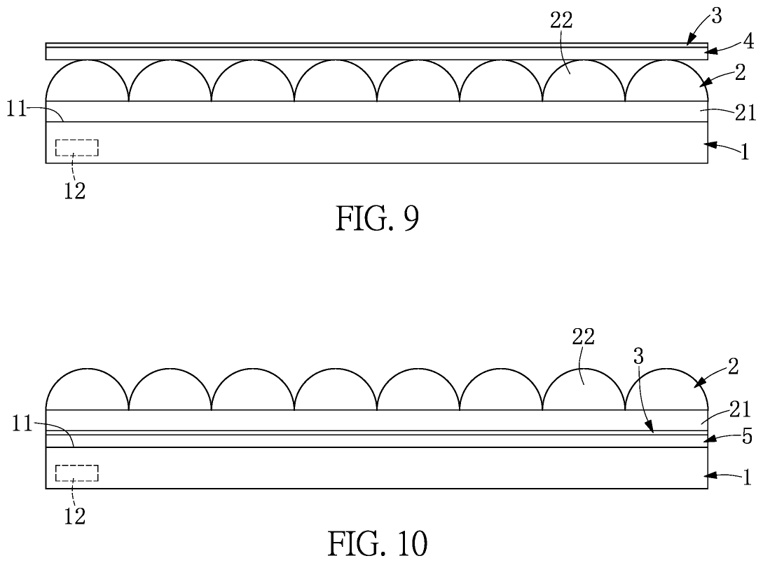

Referring to FIG. 9, a fourth embodiment of the present disclosure is illustrated, the present embodiment is substantially the same as the first embodiment, and the difference is that the stereo image display apparatus of the present embodiment further includes a movable light transmitting cover 4, and the shielding unit 3 is disposed on the movable light transmitting cover 4. The movable light transmitting cover 4 can be made of a light-transmissive material such as a glass plate or a plastic plate. The movable light transmitting cover 4 covers the lens array layer 2 such that the shielding unit 3 is disposed on the lens array layer 2. That is, the shielding unit 3 is disposed on a side of the lens array layer 2 away from the display device 1. The shielding unit 3 includes a plurality of light transmitting regions 31 and at least a light shielding region 32 as shown in FIG. 5 and FIG. 6. The light shielding region 32 is located at a periphery of the light transmitting regions 31. The light shielding region 32 is configured to shield light. The light shielding region 32 of the shielding unit 3 is configured to shield ineffective areas or edges of the lenses 22 to avoid problems such as light leakage or aberrations.

### Fifth Embodiment

Referring to FIG. 10, a fifth embodiment of the present disclosure is illustrated, the present embodiment is substantially the same as the first embodiment, and the difference is that the stereo image display apparatus of the present embodiment further includes a fixed light transmitting cover 5, and the shielding unit 3 is disposed on the fixed light transmitting cover 5. The fixed light transmitting cover 5 can be made of a light-transmissive material such as a glass plate or a plastic plate. The fixed light transmitting cover covers the display surface 11 of the display device 1 such that the shielding unit 3 is disposed on the display surface 11 of the display device 1. The shielding unit 3 includes a plurality of light transmitting regions 31 and at least a light shielding region 32 as shown in FIG. 5 and FIG. 6. The light shielding region 32 is located at a periphery of the light transmitting regions 31. The light shielding region 32 is configured to shield light. The light shielding region 32 of the shielding unit 3 is configured to shield ineffective areas or edges of the lenses 22 to avoid problems such as light leakage or aberrations.

### Sixth Embodiment

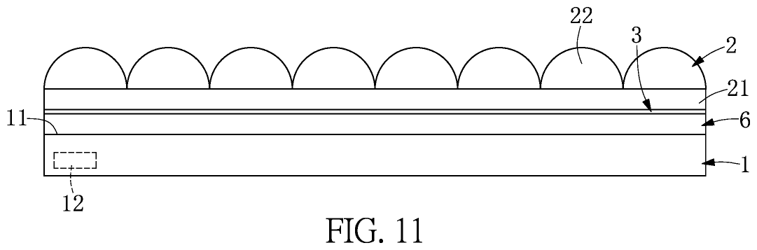

Referring to FIG. 11, a sixth embodiment of the present disclosure is illustrated, the present embodiment is substantially the same as the first embodiment, and the difference is that the stereo image display apparatus of the present embodiment further includes an intermediate medium layer 6, and the shielding unit 3 is disposed on the intermediate medium layer 6. The intermediate medium layer 6 can be made of a light-transmissive material such as a glass plate or a plastic plate. The intermediate medium layer 6 is disposed between the display device 1 and the lens array layer 2, such that the shielding unit 3 is disposed between the display device 1 and the lens array layer 2. The shielding unit 3 includes a plurality of light transmitting regions 31 and at least a light shielding region 32 as shown in FIG. 5 and FIG. 6. The light shielding region 32 is located at a periphery of the light transmitting regions 31. The light shielding region 32 is configured to shield light. The light shielding region 32 of the shielding unit 3 is configured to shield ineffective areas or edges of the lenses 22 to avoid problems such as light leakage or aberrations.

In another embodiment of the present disclosure (not shown in the drawings), the shielding unit 3 can be formed in (or by) the display device 1. The display device 1 can be liquid crystal display (LCD), micro light-emitting diode (micro LED), organic light-emitting diode (OLED) or the like. When the display surface 11 of the display device 1 displays an un-reconstructed planar image, the pixels of the display surface 11 of the display device 1 corresponding to the light shielding region 32 can be turned off, such that the shielding unit 3 can turn off the pixels that cause degradation of image quality by using a software manner to improve the image quality of the stereo image display apparatus.

In still another embodiment of the present disclosure (not shown in the drawings), the shielding unit 3 can be disposed in the display device 1. For example, the shielding unit 3 can be disposed on a backlight module of the display device 1, the shielding unit 3 can be disposed between a liquid crystal panel and a backlight module of the display device 1, or the shielding unit 3 can be disposed on an upper substrate or a lower substrate of a liquid crystal panel of the display device 1.

In conclusion, the stereo image display apparatus of the present disclosure includes a display device, a lens array layer and a shielding unit. The shielding unit can be disposed between the display device and the lens array layer. The shielding unit can also be disposed (or be formed) on the display or on the lens array layer, or in other dielectric layers. The shielding unit includes a plurality of light transmitting regions and at least a light shielding region. The light transmitting regions respectively correspond in position to the lenses of the lens array layer. The light shielding region is located at a periphery of the light transmitting regions. The light shielding region is configured to shield light. The light shielding region of the shielding unit is configured to shield ineffective areas or edges of the lenses to avoid problems such as light leakage or aberrations. Accordingly, the image quality of the stereo image display apparatus can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stereo image display apparatus capable of enhancing image quality, comprising:
a display device having a display surface and an image algorithm unit;
a lens array layer being disposed adjacent to the display surface of the display device, and the lens array layer including a plurality of lenses; and
a shielding unit being disposed between the display device and the lens array layer;
wherein the shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

2. The stereo image display apparatus capable of enhancing image quality according to claim 1, further comprising an intermediate medium layer, and the shielding unit being disposed on the intermediate medium layer; wherein the intermediate medium layer is disposed between the display device and the lens array layer, such that the shielding unit is disposed between the display device and the lens array layer.

3. A stereo image display apparatus capable of enhancing image quality, comprising:
a display device having a display surface and an image algorithm unit;
a lens array layer being disposed adjacent to the display surface of the display device, and the lens array layer including a plurality of lenses; and
a shielding unit being disposed on the display device or being disposed in the display device;
wherein the shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

4. The stereo image display apparatus capable of enhancing image quality according to claim 3, further comprising a fixed light transmitting cover, and the shielding unit being disposed on the fixed light transmitting cover; wherein the fixed light transmitting cover covers the display surface of the display device such that the shielding unit is disposed on the display surface of the display device.

5. The stereo image display apparatus capable of enhancing image quality according to claim 3, wherein the shielding unit is formed in the display device; when the display surface of the display device displays the un-reconstructed image, the pixels of the display surface of the display device corresponding to the light shielding region are capable of being turned off, such that the shielding unit is capable of turning off the pixels by using a software manner.

6. A stereo image display apparatus capable of enhancing image quality, comprising:
a display device having a display surface and an image algorithm unit;
a lens array layer being disposed adjacent to the display surface of the display device, and the lens array layer including a plurality of lenses; and
a shielding unit being disposed on the lens array layer;
wherein the shielding unit includes a plurality of light transmitting regions and at least one light shielding region, the light shielding region is located at a periphery of the light transmitting regions, the light transmitting regions respectively correspond in position to the lenses, and the lens array layer is configured to reconstruct an un-reconstructed image displayed by the display surface as an integral image to produce a stereo image.

7. The stereo image display apparatus capable of enhancing image quality according to claim 6, wherein the shielding unit is disposed on a side of the lens array layer that is away from or close to the display device.

8. The stereo image display apparatus capable of enhancing image quality according to claim 6, further comprising a movable light transmitting cover, and the shielding unit being disposed on the movable light transmitting cover; wherein the movable light transmitting cover covers the lens array layer such that the shielding unit is disposed on the lens array layer.
